(19) United States
(12) Patent Application Publication
(10) Pub. No.: US 2011/0040593 A1
(43) Pub. Date: Feb. 17, 2011

(54) INTEGRATION OF THE MANAGEMENT OF INTERVENTIONS ON EQUIPMENT WITH A DAILY LABORATORY ANALYSIS WORK IN A LIMS

(75) Inventor: FRÉDÉRIC DEPRETER, LE ROEULX (BE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, MUENCHEN (DE)

(21) Appl. No.: 12/855,821

(22) Filed: Aug. 13, 2010

(30) Foreign Application Priority Data
Aug. 13, 2009 (EP) 09 167 785

(51) Int. Cl. G06Q 10/00

(52) U.S. Cl. 705/7; 705/1.1

(57) ABSTRACT

A method and a system for managing in a laboratory information management system (LIMS) at least one intervention on at least one piece of equipment managed by the LIMS, and in particular with at least a daily analysis work. The system contains at least one equipment intervention management module integrated to the LIMS, a device for defining in the equipment intervention management module, intervention management rules for the equipment managed by the LIMS, a device for defining in the equipment intervention management module, at least one intervention process for the equipment, and a device for executing the intervention.

### CROSS-REFERENCE TO RELATED APPLICATION

This application claims the priority, under 35 U.S.C. §119, of European application EP 09167785, filed Aug. 13, 2009; the prior application is herewith incorporated by reference in its entirety.

### BACKGROUND OF THE INVENTION

### Field of the Invention

The present invention relates generally to a laboratory information management system (LIMS) and specifically to a method and a system for integrating a management of interventions on laboratory or process line equipment with a daily analysis work in a LIMS.

As it is well known, a method for managing and controlling manufacturing and/or analysis processes planned by enterprise resource planning (ERP) and produced by a technical process line, provides in the environment of a manufacturing executing system (MES) an automation system for implementing the planned analysis processes and controlling the corresponding workflow steps at the level of the technical process line.

In particular, enterprise resource planning (ERP) is a system including hardware devices and corresponding software applications for planning the business resources of an enterprise, i.e. material provisions, human resource managements, purchasing, orders, profits, finance, inventory controls, customer management, etc., while the term “technical process line” refers to a system supporting the control of single machines involved in the analysis processes, for example by measuring the number of pieces handled per hour by each machine or the functioning parameters thereof, the quality of the analysis results and so on.

MES is an intermediate layer providing computing machines and software tools between the ERP upper layer and the process line lower layer, including a software tool for analysis management, which receives requests of analysis from the ERP, and a software tool for productive process, which supports the phases of selecting and managing the resources to be involved in the productive processes, i.e. employees, machines and materials, in order to realize a planned analysis process within required time constraints.

MES is based on the International Standard Association (ISA) standard S95 which defines how software tools may implement the productive process at plant floor level and how to communicate with it. Beside the productive process itself, it is crucial for many industries to control the productive process in terms of analysis, measurements and traceability of the products, like for example for pharmaceutical industry, food industry, high-tech industry, or for industries where the productive process itself is a process of analyzing a sample, i.e. medical diagnostic analysis, material science analysis, drug scanning and so on.

These results of an analysis process are typically managed by software processes which are closely related to the MES software. Siemens Corporation is distributing this kind of software under its trade name “SIMATIC IT UNILAB®”. This type of software is typically called a laboratory information management system (LIMS) software. It manages the results of the analysis and/or measurements from laboratories or production lines, in particular with a determined aspect on the traceability of the sample or production results. Usually, all these results are related to a distinct sample, or lot which is reflected in an electronic sample record corresponding to the physical sample. During the workflow along the technical process line, the electronic sample records also status information corresponding to the actual status of the physical sample. Typical statuses are for example “Arrived in Laboratory”, “Ready for analysis”, “Analyzed”, “To be inspected by Lab Manager”, “Repeat analysis” and so on.

Thus, the LIMS software is usually a multi-purpose user-friendly configurable software for manufacturing processes in different types of laboratories, which implies consequently a large immanent need of customization of this software. For example, it typically models and manages complete workflows of data in labs or production lines, such as results of analysis, data acquisition, samples measurements or also reports. In LIMS software, the handling of data generated, for example, by instrumentations, procedures, workflow, or arising from database, or also the synchronization of manufacturing processes with business processes and complex supply chains, are usually automated and configurable. In particular, LIMS software allows to execute analysis by a user-friendly input form containing for example multiple fields. Some of these fields might be, for example, filled in by a user for calculation purposes, or might simply report analysis or results coming from equipment or a whole process line. By equipment we refer in particular to any instrument or machine contained in a laboratory or in a process line. Due to its flexibility, scalability and business-related benefits, LIMS softwares provide solutions of a wide variety of industrial processes.

Thereby, typical tasks managed by LIMS software are generally presented to the user in an interactive input form that allows for example: to execute analysis based on multiple fields filled in particular either automatically, or by the user; to perform some calculations based on the filled field.

Although the LIMS software is standard software which satisfies numerous demands of laboratory operator, it actually does not allow a management of an intervention that has to be realized on a laboratory or process line equipment. Thus, we can differentiate two types of softwares, on one hand LIMS softwares doing typical tasks, such as normal measurements methods, including for example at least an analysis execution with a multiple fields input form and calculations based on the multiple fields, and on the other hand softwares dedicated to intervention management on equipments, like for example the calibration of a laboratory instrument.

Effectively, the state of the art proposes on one hand, software for interventions on equipment—hereafter called intervention software—and on the other hand, LIMS software for managing results of analysis or measurements of equipment, the softwares being unable to communicate the one with the other one, due to high complexity of their code basis. Consequently, two different softwares, respectively the LIMS software and the intervention software, are always needed in order to manage, respectively, results of analysis or measurements provided by some equipment, and interventions realized on the equipment itself. In other words, there is an impassable separation between equipment management (i.e. for example what an instrument is doing and how we control it), and equipment intervention management (i.e. management of interventions related to the instrument itself, the intervention being for example a calibration process that updates automatically some parameters of the equipment, the calibration being done at a specific frequency).

In other words, no LIMS software provides a flexible and compatible management of interventions that have to be done on a laboratory or process line equipment, based for example on a specific scheduling of the calibration in dependence on critical parameters or time, or also a maintenance or a cleaning of the equipment, that has to be executed for at least one piece of equipment in order to prevent a malfunction of the equipment, or to guarantee their correct working. It means that in order to manage on the one hand complete workflows of data in labs or production lines and, on the other hand, labs or production lines equipment interventions, an operator has to run one particular software for intervention processes for the equipment, the software being generally specific to a unique instrument, and another software, such as a LIMS, for managing the complete workflow of data. Actually, interventions on equipment involved in a production line or a laboratory have to be managed by an operator, who will check for example for each equipment parameters related to an intervention (calibration, cleaning, maintenance, etc.) and decide if it has to be done or not. Such procedure is on one hand time consuming and, on the other hand, might be a source of human errors.

### SUMMARY OF THE INVENTION

It is accordingly an object of the invention to provide an integration of management of interventions on equipment with a daily laboratory analysis work in a LIMS which overcome the above-mentioned disadvantages of the prior art methods and devices of this general type, in which the LIMS software is able to manage directly the interventions that have to be done for the equipment, such as calibration, maintenance or cleaning.

The objective is achieved according to the present invention with respect to the method by a method for managing, in a LIMS, in particular in LIMS software, at least one intervention on at least one piece of equipment managed by the LIMS, in particular managed by the LIMS software, and in particular with at least a daily analysis work. The method includes the steps of defining in an equipment intervention management module integrated with the LIMS, intervention management rules for the equipment managed and/or controlled by the LIMS or the LIMS software and defining in the equipment intervention management module integrated with the LIMS, at least one intervention process for the equipment. The intervention is executed, in particular in accordance with the defined rules and intervention process.

The objective is achieved according to the present invention with respect to the system by a system for managing, in a LIMS, in particular in LIMS software, at least one intervention on at least one piece of equipment managed by the LIMS, in particular managed by the LIMS software, and in particular with a daily analysis work. The system contains at least one equipment intervention management module integrated with the LIMS and interacting with it, a device for defining in the equipment intervention management module, intervention management rules of the equipment managed and/or controlled by the LIMS or LIMS software, and a device for defining in the equipment intervention management module, at least one intervention process for the equipment, notably by interactions between the LIMS, or LIMS software, and the intervention management module. The system further has a device for executing the intervention, in particular in accordance with the defined rules and intervention process.

In particular, the equipment intervention management module allows integration in LIMS software an input form related to interventions on equipment, and the module is in particular able to communicate and exchange information with the instrument. Therefore, the method and the system provide a reliable and easy way to manage interventions on equipment within a LIMS, in particular LIMS software, by integrating the management of interventions to directly to the LIMS or LIMS software. According to one embodiment of the invention, the intervention management rules contains at least an intervention scheduling, for example in dependence on the time or in dependence on equipment parameters, or also in dependences of other equipment processes, that are involved, for example, in a same production line. In particular, a device for intervention scheduling, for example in dependence on time or equipment parameters, allows too plan the interventions realized on equipment. Advantageously, the intervention scheduling contains at least intervention frequencies, which might be for example defined in dependence on the time, or in dependence on the number of times the equipment has been used, resulting either in time dependence or in use dependence of the intervention. The intervention management rules might be in particular pre-recorded in the intervention management module, or created by an operator, so that the interventions are completely customizable by the user. Consequently, a definition of the intervention management rule is sufficiently flexible and configurable so that the rules are adaptable to any equipment.

According to a preferred embodiment, the invention contains measures for defining a warning period before a scheduled intervention and measures for defining a grace period during which the equipment might be used even if the scheduled intervention did not take place as planned by the intervention scheduling. Consequently, the intervention due date is at least bordered by a first period, the warning period that takes place before the intervention due date, and a second period, the grace period, that takes place after the intervention due date and warns the equipment user that an intervention did not take place and should be done as soon as possible. Advantageously, while using LIMS software, a user working with the equipment gets, in particular, at least one intervention warning when the equipment is in the warning period or in the grace period. Moreover, the method according to the invention contains in particular a step of preventing any use of the equipment during the intervention. In order to do this, preventing means are for example advantageously comprised in the equipment intervention management module. For example, a user executing with the LIMS an analysis with an input form cannot execute the analysis if the intervention is in process, or if the grace period is finished or also if the intervention has failed. Advantageously, if an intervention fails, or simply in the case of intervention malfunction, the method contains, in particular, a step of executing a troubleshooting procedure that alerts an operator and/or the equipment user. The troubleshooting procedure is for example supported by troubleshooting means advantageously contained in the equipment intervention management module.

In particular, the intervention contains at least an equipment calibration. Effectively, measures for executing the equipment calibration are advantageously integrated with the equipment intervention management module. The method according to the invention allows thus to build a calibration schedule for an equipment in dependence on a temporal scale or in dependence on the number of times the equipment is used, in particular by interactive tools contained in the equipment intervention management module, that help a user in constructing a feasible and reliable calibration schedule. Calibration operations that have to be scheduled are in particular represented by tasks that keep busy one or more resource of the equipment for a known amount of time. Moreover, a preferred embodiment of the invention provides measures for managing at least one result of the calibration intervention and updating at least one parameter of the equipment in dependence on the result of the calibration intervention. Thereby, the method according to the invention is in particular characterized by a step of managing at least one result of the calibration and updating at least one equipment parameter in dependence on the result of the calibration. Typically, a calibration results in one or more corrections factors, for example some constants, that have to be used for all measurements executed with that equipment after the calibration, in order to guarantee that the equipment is working correctly and providing correct results or measurement values. By updating equipment parameters with these factors, the equipment passes from a state of pre-calibration comprised either in the warning period or the grace period, to a ready working state.

Other features which are considered as characteristic for the invention are set forth in the appended claims.

Although the invention is illustrated and described herein as embodied in an integration of management of interventions on equipment with a daily laboratory analysis work in a LIMS, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWINGS

FIG. 1 is a schematic illustration of an example of typical management of an intervention on equipment according to the invention;

FIG. 2 is a schematic illustration of an example of a possible workflow for an intervention; and

FIG. 3 is a block diagram of an system for executing the method according to the invention.

### DETAILED DESCRIPTION OF THE INVENTION

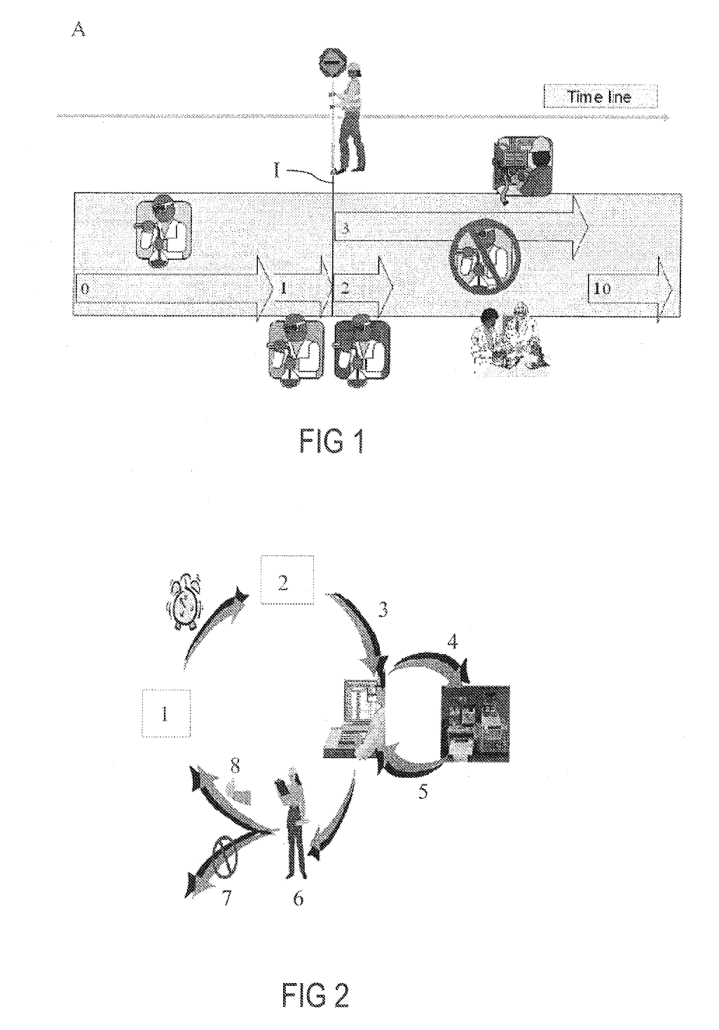

FIG. 1 schematically represents an example of typical intervention management on equipment. The intervention takes place during a normal usage phase of the equipment. This intervention might be for example equipment calibration, cleaning or maintenance. The intervention might appear periodically, in dependence on the time or in dependence on the number of times the equipment is used, but also in dependence on a critical parameter of the equipment, the parameters being for example defined by a user. Consequently, different periods are defined in a life loop of the equipment as shown in FIG. 1. The life loop shows a period of normal usage 0 of the equipment: the equipment is working normally and no interventions are recorded for this period and a warning period 1. During the warning period 1, a normal usage of the equipment is possible, but the user is informed about a future intervention I that will take place soon. If the intervention does not take place, then a grace period 2 is defined: during the period, a user can still use the equipment, but he is warned about the intervention that did not take place at the scheduled time. Consequently, some parameters might for example not be exact, and the user is advantageously informed about the working state of the equipment, during an intervention period 3. The intervention period might begin at the scheduled date for the intervention, but, in any case, the intervention period 3 takes place at the end of the grace period. During the intervention period, it becomes impossible to use the equipment, and consequently, means are provided for preventing a user from using the equipment and to inform the user of the non working state of the equipment. Once an intervention is finished, a new period of normal usage 10 begins, and the life loop is closed.

The normal usage period 0 and the warning period 1 correspond to a normal intervention period: the user is for example warned that an intervention is soon due, but normal operation can go on. At the opposite, during the grace period 2, the user is informed that the equipment is in its grace period and that normally an intervention is required to guarantee for example the correct functioning of the equipment, or correct measurement values.

FIG. 2 schematically represents an example of a possible workflow for an intervention according to a series of successive steps. First the intervention 1 is monitored in order to define for example an intervention process or frequency. Second an intervention sample/method 2 is automatically created at a scheduled date of the intervention. Third, an assignment to a work list 3 is performed in order for example to execute the intervention process. Fourth, a performance of the intervention 4 is performed: the intervention itself takes place. It is for example a calibration process of an instrument or a machine. Fifth, the entry of the intervention results 5 is performed, for example the calibration process results in correction factors that have to be taken into account for the correct working of the instrument. Sixth, the intervention 6 is validated: for example, before to change the state of the equipment from an out of calibration state to a calibrated state, an operator or a user checks the parameters of the equipment. Seventh, corrective actions 7 are listed: if the intervention failed, the equipment stays in a non working state, and new interventions have to be done in order to bring the equipment in a working state. Eighth, if the intervention succeeded 8, the workflow continues, with for example monitoring a new intervention.

Finally, the method and the system according to the invention have the following advantages. First, a user working for example on an analysis with the LIMS software gets intervention warnings when the equipment used is in the warning or grace period. Second, a user working for example on an analysis with the LIMS cannot execute the analysis if the grace period is finished, or if the intervention is in process or if the last intervention failed. Third, a user may perform an intervention with the LIMS software in order to bring the equipment into a working state, whereas two different softwares were needed in the prior art in order to do the intervention and normal LIMS software tasks. Fourth, no apparent difference between a “normal sample” and an “intervention sample” for the final user. He can handle these 2 types of samples in the same way. More precisely, a sample is a standard object in a LIMS typically related to a material (solid, liquid, gas) that should be analyzed in the laboratory. We can differentiate normal sample/method, that is related to product analysis, and intervention sample/method, that is related for example to an action on an instrument like its calibration. Only the effect of the execution of the sample differs if it is a “normal sample” related for example to product analysis, or an “intervention sample”, related for example to the calibration of an instrument. Indeed, the effect of the execution of a normal sample is typically delivering the analysis results of a product, providing for example some statistics on a product that is processed by an instrument. The effect of the execution of intervention sample/methods is different. Indeed, the effect of the execution of an intervention sample is typically, for example, in the case of a calibration, delivering new equipment constants and a new status for the equipment. Of course, the users are handling the two types of samples, normal samples and intervention samples, in the same way, the only difference being found in the result or effect of the execution of the samples. In particular, there are no special forms in the LIMS dedicated to the execution of the intervention sample/method, in other words, the forms are not specific to the type of sample. Fifth, a unique database is used for running the LIMS software and the interventions, and collecting data, so that all information related to the equipment is inside one data model which makes the auditing of equipment activities more easy and reliable. Sixth, there is no need of collecting data from two different softwares with two different data models related to interventions and LIMS typical tasks in order to build up the history of the equipment, and thus resulting in an improved traceability. Seventh, a unique software is used to manage interventions and typical LIMS tasks.

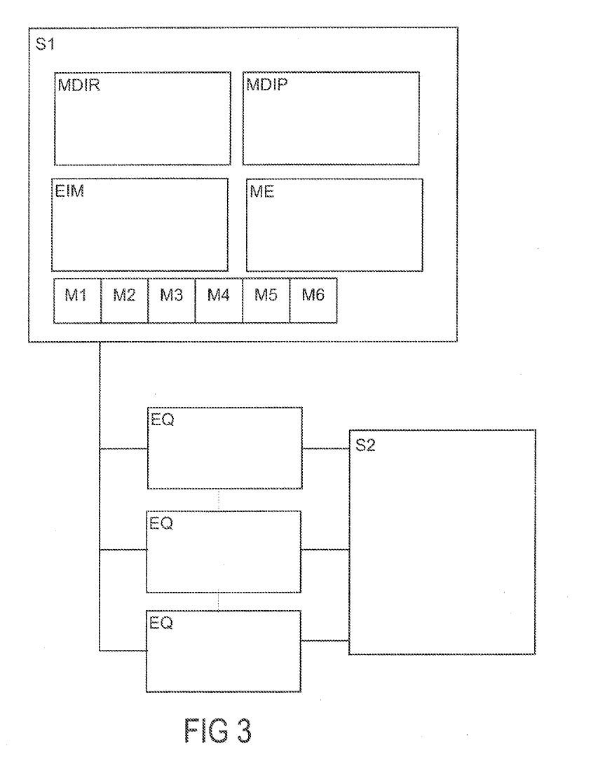

FIG. 3 is a block diagram of a system S1 for managing at least one intervention on various pieces of equipment EQ. The system S1 is defined by at least one equipment intervention management module EIM and is associated with a laboratory information management system (LIMS) S2. The system S1 has means MDIR for defining in the equipment intervention management module EIM, intervention management rules for the equipment EQ managed by the laboratory information management system S2. The system S1 has means MDIP for defining in the equipment intervention management module EIM, at least one intervention process for the equipment EQ and means for executing ME the intervention. The system S1 further has means for intervention scheduling M1, means for defining a warning period M2 before the intervention, and means for defining a grace period M3 during which the equipment EQ might be used even if a scheduled intervention did not take place as planned by the means for intervention scheduling M1. Additionally, the system S1 has means M4 for preventing any use of the equipment EQ during the intervention, at least means for executing an equipment calibration intervention M5, and means for managing at least one result of the equipment calibration intervention and updating at least one parameter of the equipment in dependence on a result of the equipment calibration intervention M6.

1. A method for managing, in a laboratory information management system (LIMS), at least one intervention on at least one piece of equipment managed by the laboratory information management system, which comprises the steps of:
defining in an equipment intervention management module integrated with the laboratory information management system, intervention management rules for the equipment;
defining in the equipment intervention management module integrated in the laboratory information management system, at least one intervention process for the equipment; and
executing the intervention.

2. The method according to claim 1, wherein the intervention management rules include at least an intervention scheduling.

3. The method according to claim 2, wherein the intervention scheduling has at least intervention frequencies.

4. The method according to claim 1, which further comprises defining a warning period before the intervention.

5. The method according to claim 2, which further comprises defining a grace period during which the equipment might be used even if a scheduled intervention did not take place as planned by the intervention scheduling.

6. The method according to claim 1, which further comprises preventing any use of the equipment during the intervention.

7. The method according to claim 1, wherein the intervention contains at least an equipment calibration.

8. The method according to claim 7, which further comprises managing at least one result of a calibration and updating at least one equipment parameter in dependence on the result of the calibration.

9. A system for managing, in a laboratory information management system, at least one intervention on at least one piece of equipment managed by the laboratory information management system, the system comprising:
at least one equipment intervention management module integrated with the laboratory information management system;
means for defining in said equipment intervention management module, intervention management rules for the equipment managed by the laboratory information management system;
means for defining in said equipment intervention management module, at least one intervention process for the equipment; and
means for executing the intervention.

10. The system according to claim 9, further comprising means for intervention scheduling.

11. The system according to claim 9, further comprising means for defining a warning period before the intervention.

12. The system according to claim 10, further comprising means for defining a grace period during which the equipment might be used even if a scheduled intervention did not take place as planned by said means for intervention scheduling.

13. The system according to claim 9, further comprising means for preventing any use of the equipment during the intervention.

14. The system according to claim 9, further comprising at least means for executing an equipment calibration intervention.

15. The system according to claim 14, further comprising means for managing at least one result of the equipment calibration intervention and updating at least one parameter of the equipment in dependence on a result of the equipment calibration intervention.
